(19) United States
(12) Patent Application Publication
(10) Pub. No.: US 2008/0013159 A1
(43) Pub. Date: Jan. 17, 2008

(54) LOW COST VERTICAL FABRY-PEROT POLYMER/SOL-GEL ELECTRO-OPTIC MODULATORS

(75) Inventors: Mahmoud Fallahi, Tucson, AZ (US); Nasser N. Peyghambarian, Tucson, AZ (US); Robert A. Norwood, Tucson, AZ (US)

Correspondence Address: OBLON, SPIVAK, MCCLELLAND MAIER & NEUSTADT, P.C., 1940 DUKE STREET, ALEXANDRIA, VA, 22314, US

(73) Assignee: THE ARIZONA BD OF REG ON BEHALF OF THE UNIV OF AZ, Tucson, AZ (US)

(21) Appl. No.: 11/768,661

(22) Filed: Jun. 26, 2007

Related U.S. Application Data
(60) Provisional application No. 60/816,552, filed on Jun. 26, 2006.

(51) Int. Cl. G02F 1/00

(52) U.S. Cl. 359/321

(57) ABSTRACT

An optical device including: a first transparent substrate; a first electrode disposed on the first transparent substrate; a first mirror disposed on the first electrode; a high electro-optic coefficient polymer or sol-gel material disposed on the first mirror; a second mirror disposed on the high electro-optic coefficient polymer or sol-gel material and at least partially sandwiching the sol-gel material between the first and second mirrors; a second electrode disposed on the second mirror; and a second transparent substrate disposed on the second electrode.

### CROSS-REFERENCE TO RELATED APPLICATIONS

This application claims the benefit of priority under 35 U.S.C. §119(e) from provisional Application Ser. No. 60/816,552, filed Jun. 26, 2006, the entire contents of which are hereby incorporated by reference.

### STATEMENT REGARDING FEDERALLY SPONSORED RESEARCH OR DEVELOPMENT

This invention was made with government support under Contract Number DMR0120967 awarded by the National Science Foundation. The government has certain rights in the invention.

### BACKGROUND OF THE INVENTION

1. Field of the Invention

The present invention generally relates to the field of optical communication technology, and more particularly to an electro-optic Fabry-Perot interferometer used in optical communication systems.

The present invention includes the use of various technologies referenced and described in the documents identified in the following LIST OF REFERENCES, some of which are cited in the specification by the corresponding reference number in brackets:

### LIST OF REFERENCES

[1] C. A. Eldering, S. T. Kowel, and A. Knoesen, Appl. Opt. 28, 4442 (1989);

[2] C. A. Eldering, S. T. Kowel, M. A. Mortazavi, and P. F. Brinkley, Appl. Opt. 29, 1142 (1990);

[3] G. Hernandez and K. C. Klark, Appl. Opt. 33, 1989 (1994);

[4] R. M. Roth, T. Izuhara, R. L. Espinola, D. Djukic, and R. M. Osgood, Jr., Opt. Lett. 30, 994 (2005);

[5] J. S. Patel, M. A. Saifi, D. W. Berreman, C. Lin, N. Andreadakis, and S. D. Lee, Appl. Phys. Lett. 57, 1718 (1990);

[6] K. Hirabayashi, H. Tsuda, and T. Kurokawa, J. Lightwave Technol. 11, 2033 (1993);

[7] D. Y. Jeong, Y. H. Ye, and Q. M. Zhang, Appl. Phys. Lett. 85, 4857, (2004);

[8] S. N. Levine, J. Appl. Polym. Sci. 9, 3351 (1965);

[9] C. A. Eldering, A. Knoesen, and S. T. Kowel, J. Appl. Phys. 69, 3676 (1991);

[10] M. Lee, H. E. Katz, C. Erben, D. M. Gill, P. Gopalan, J. D. Heber, and D. J. McGee, Science 298, 1401 (2002);

[11] L. Dalton, B. Robinson, A. Hen, P. Ried, B. Eichinger, P. Sulivan, A. Akelaitis, D. Bale, M. Haller, J. Luo, S. Liu, Y. Liao, K. Firestone, N. Bhatambrekar, S. Bhattacharjee, J. Sinness, S. Hammond, N. Buker, R. Snoeberger, M. Lingwood, H. Rommel, J. Amend, S. H. Jang, A. Chen, and W. Steier, Proc. SPIE 5935, 593502 (2005);

[12] A. K. Jen, J. Luo, T. D. Kim, B. Chen, S. H. Jang, J. W. Kang, N. M. Tucker, S. Hau, Y. Tian, J. W. Ka, M. Haller, Y. Liao, B. Robinson, L. Dalton, and W. Herman, Proc. SPIE 5935, 593506 (2005);

[13] H. Zhang, H. Gan, D. Lu, and M. Fallahi, Proc. SPIE 5935, 593508 (2005);

[14] H. X. Zhang, D. Lu. N. Peyghambarian, M. Fallahi, J. D. Luo, B. Q. Chen, and A. K. Y. Jen, Opt. Lett. 30, 117 (2005);

[15] J. G. Grote, J. S. Zetts, R. L. Nelson, F. K. Hopkins, L. R. Dalton, C. Zhang, and W. H. Steier, Opt. Eng. (Bellingham) 40, 2464 (2001);

[16] G. Xu, Z. Liu, J. Ma, B. Liu, S. T. Ho, L. Wang, P. Zhu, T. J. Marks, J. Luo, and A. K. Y. Jen, Opt. Express 13, 7380 (2005);

[17] Gan et al., Applied Physics Letters 89, 041127 (2006);

[18] Hybrid Fabry-Perot etalon using an electro-optic polymer for optical modulation, applied physics letters, 89, 2006; and

[19] U.S. Pat. No. 6,868,199.

### DESCRIPTION OF THE RELATED ART

An electro-optic modulator (EOM) is an optical device in which a signal-controlled element displaying the electro-optic effect is used to modulate a beam of light. Fabry-Perot interferometers (FPI's) using electro-optic polymers have been recognized as promising electro-optic modulators and tunable filters for global optical interconnection and free space communications. Specifically, conventional FPI's have been used in telecommunication systems, and in laser and spectroscopy applications to control and measure the wavelength of light.

More particularly, the Fabry-Perot interferometers may be used in conjunction with optical switches to allow multiplexing and de-multiplexing of a number of wavelength channels in one optical fiber.

For example, optical fiber networks utilize wavelength division multiplexing (WDM) to combine many optical signals at different wavelengths for transmission in a single optical fiber. WDM networks require fast and efficient switches for use in routing packets to different locations on the network. Different methods of optical switching have been conventionally known or used. For example, there are micro-electrical-mechanical systems, inject BUBBLE, optical liquid crystals, and thermal-optic optical switches. However, these types of optical switches suffer from slow switching times.

Other switches, such as planar waveguide optical switches (e.g., lithium niobate or indium phosphide planar-based switch) have faster switching times (10 nanoseconds or faster) than the switches mentioned above. However, these switches are not capable of wavelength selection.

Electro-optic polymer devices, when compared to inorganic crystals, liquid crystals, and electrostrain polymers, can operate at very high speeds. In addition, the fabrication flexibility of polymers makes it easy to incorporate the film devices into integrated circuits and onto surfaces of CMOS (complementary metal-oxide-semiconductor) devices.

However, conventional Fabry-Perot modulators, in both transmission and reflection structures, have very low modulation efficiency and need a very high drive voltage due to the low hyperpolarizability of conventional azo-type chromophores.

With conventional approaches and techniques, high performance FPI's based solely on the pure EO effect are very difficult to achieve since a significant change of refractive index requires extremely large EO coefficients, though the synthesis of novel NLO chromophores with very large hyperpolarizability is advancing the field rapidly [11, 12]. However, for FPI tunable filters working at approximately millisecond speed, electromechanical effects such as the inverse piezoelectric effect of the EO polymer materials can also play an important role when an extremely large dipole moment is created by the poling process [8].

### SUMMARY OF THE INVENTION

One object of the present invention is to address the above-identified and other limitations of conventional data backup and recovery utilities. Another object is to provide a low cost, efficient, and high speed optical modulator.

One aspect of the present invention includes an optical device including: a first transparent substrate; a first electrode disposed on the first transparent substrate; a first mirror disposed on the first electrode; a high electro-optic coefficient polymer or sol-gel material disposed on the first mirror; a second mirror disposed on the high electro-optic coefficient polymer or sol-gel material and at least partially sandwiching the high electro-optic coefficient polymer or sol-gel material between the first and second mirrors; a second electrode disposed on the second mirror; and a second transparent substrate disposed on the second electrode.

In another aspect of the present invention, the at least one of the first mirror and second mirror is a distributed Bragg reflector.

In another aspect of the present invention, the at least first or second electrode includes indium tin oxide.

In another aspect of the present invention, the distributed Bragg reflector has a reflectivity of 99% at a wavelength of 1550 nm

In another aspect of the present invention, the first and second electrodes are transparent.

In another aspect of the present invention, the high electro-optic coefficient polymer or sol-gel material includes one of AJL8 or chromophore TCBD.

In another aspect of the present invention, the chromophore TCBD is (3-[5-(2-{4-[Bis-(2-hydroxy-ethyl)-amino]-phenyl}-vinyl)-thiophen-2-yl]-2,5-dicyano-4-[3-(3-hydroxy-propoxy)-phenyl]-hexa-2,4-dienedinitrile).

In another aspect of the present invention, the first and second mirrors are disposed to form a gap, which is partially filed by the high electro-optic coefficient polymer or sol-gel material.

In another aspect of the present invention, the high electro-optic coefficient polymer or sol-gel material is biased by a voltage source that establishes an electric field between the first and second electrodes.

In another aspect of the present invention, the at least one of the first and second electrodes includes zinc.

Another aspect of the present invention includes a method of making an optical modulator including: depositing a first transparent electrode on a first transparent substrate; depositing a first low loss mirror onto the first electrode; depositing a high electro-optic coefficient polymer or sol-gel material onto the low loss mirror; depositing a second low loss mirror onto the high electro-optic coefficient polymer or sol-gel material; depositing a second transparent electrode onto the second low loss mirror; and depositing a second transparent substrate on the second electrode.

In another aspect of the present invention, the depositing the first low loss mirror includes depositing a distributed Bragg reflector.

In another aspect of the present invention, the depositing the first electrode includes depositing indium tin oxide.

In another aspect of the present invention, the depositing the distributed Bragg reflector includes depositing a distributed Bragg reflector that has a reflectivity of 99% at a wavelength of 1550 nm.

In another aspect of the present invention, the depositing the first electrode includes depositing a transparent electrode.

In another aspect of the present invention, the depositing the high electro-optic coefficient polymer or sol-gel material includes depositing at least one of AJL8 or chromophore TCBD.

In another aspect of the present invention, the depositing chromophore TCBD includes depositing (3-[5-(2-{4-[Bis-(2-hydroxy-ethyl)-amino]-phenyl}-vinyl)-thiophen-2-yl]-2,5 -dicyano-4-[3 -(3-hydroxy-propoxy)-phenyl]-hexa-2,4-dienedinitrile).

In another aspect of the present invention, an optical device includes: a first transparent substrate; a first mirror disposed on the first transparent substrate; a first electrode disposed on the first mirror; a high electro-optic coefficient polymer or sol-gel material disposed on the first electrode; a second electrode disposed on the high electro-optic coefficient polymer or sol-gel material and at least partially sandwiching the high electro-optic coefficient polymer or sol-gel material between the first and second electrodes; a second mirror disposed on the second electrode; and a second transparent substrate disposed on the second mirror.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is an optical modulator according to an embodiment of the present invention;

FIG. 1B is another optical modulator according to an embodiment of the present invention;

FIG. 2 is a plot that shows a relationship between Pockel's coefficient and a poling voltage;

FIG. 3 is an exemplary test setup for an embodiment of the present invention;

FIG. 4 is a plot that shows a shift in the resonance wavelength of a sol-gel cavity;

FIG. 5 is a plot that shows the dependence of the wavelength shift on the applied voltage;

FIG. 6 is a plot that shows the power change at different applied voltages, recorded from an optical spectrum analyzer with a sweep resolution of 0.2 nm;

FIG. 7 is a plot that shows the dependence of modulation efficiency on applied voltage;

FIG. 8 is a trace comparing the dynamic modulation and applied voltage; and

FIGS. 9A and 9B show exemplary results obtained using an embodiment of the present invention.

### DETAILED DESCRIPTION OF THE PREFERRED EMBODIMENTS

Referring now to the drawings, wherein like reference numerals designate identical or corresponding parts throughout the several views.

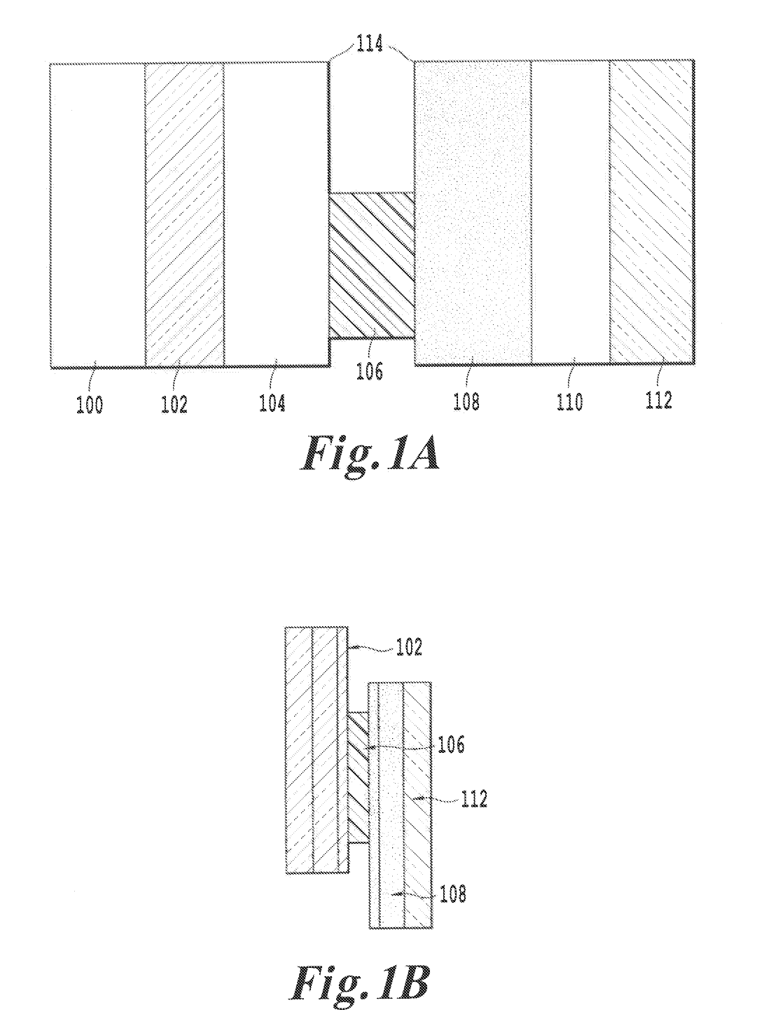

FIG. 1 is an exemplary Fabry-Perot interferometer (FPI) embodying the present invention. As shown in FIG. 1, the FPI device has a symmetric structure. On glass substrate 100, a highly conductive 100 nm thick ITO (indium transparent oxide) layer 102 is sputtered onto the glass substrate 100 to form an electrode. Then, a low loss mirror 104, such as a DBR (distributed Bragg reflector) stack of eight pairs of SiO₂/Ta₂O₅ [(L|H)⁸, 230 nm/200 nm in thickness] is coated on the ITO layer 102. The reflectivity of the DBR stack may be approximately 99.0% at ˜1550 nm. A high electro-optic coefficient material 106 is spin-coated onto the DBR surface 104, soft baked at 100° C. for 10 min, and then corona poled at 170° C. for 30 minutes to improve its wettability and adhesion characteristics for coating. The high electro-optic coefficient material may be a sol-gel or a polymer (i.e., AJL8/APC). High electro-optic coefficient materials are sol-gels or polymers that have an electro-optic coefficient that is greater than 30 picometer/volt. The propagation loss of the film is ˜1. dB/cm at 1550 nm. Since the light modulator is symmetric, another piece of DBR 108 and ITO 110 coated glass 112 are brought into close contact with the high electro-optic coefficient material and then packaged with UV curable epoxy. Thus, mirrors 104 and 108 at least partially sandwich the high electro-optic coefficient material to form a partially filed cavity 114. In this structure, the ITO electrodes 102 and 110 are put outside of the cavity to avoid high loss caused by their plasma reflection and large extinction coefficient (i.e., an electromagnetic wave has a difficult time passing through the material). Embodiments with the ITO electrodes on the outside of the cavity have reduced absorption loss and increased cavity finesse (defined as the ratio between the cavity free spectral range and the cavity linewidth).

When an electrical field is applied to the high electro-optic coefficient material through electrodes 102 and 110, the refractive index and/or physical thickness of the high electro-optic coefficient material changes and the resonant wavelength shifts to a new resonant condition.

In the embodiment discussed above and shown in FIG. 1A, a low insertion loss of 5 dB has been observed with the ITO electrodes. However, insertion loss can be reduced by switching from an ITO to a ZnO transparent electrode.

In an alternative embodiment of the present invention, each side of the FPI may be off-set, as shown in FIG. 1B and the electrodes may be on the inside of the cavity. This configuration provides for a much higher field than is possible when the electrodes are outside the cavity, for the same applied voltage. This leads to much lower operating voltages. Furthermore, it is likely that contact polling could be used instead of corona polling if the transparent conducting electrodes could be placed in direct contact with the EO film.

In operation, the varying transmission function of the FPI is caused by interference between the multiple reflections of light between the reflecting surfaces (DBR). Within the FPI, light enters and undergoes multiple internal reflections. Constructive interference occurs if the transmitted beams are in phase, which corresponds to a transmission maximum. If the transmitted beams are out-of-phase, destructive interference occurs and this corresponds to transmission minimum.

The choice of cladding and buffer materials in poled electro-optic EO polymer based devices has a major impact on device performance. An organic/inorganic photopatternable hybrid sol-gel was found to have higher conductivity than typical EO polymers, excellent resistance to EO polymer solvents, high thermal stability (>150° C.), low optical loss, and index tunability. All of these factors make this organic/inorganic photopattemable hybrid sol-gel material an excellent choice as a cladding material in electro-optic polymer based devices. For example, the EO coefficient of AJL8 doped in amorphous polycarbonate (APC) has been enhanced by more than a factor of 2 by using a 5 micron organic/inorganic hybrid sol-gel cladding layer, which can have a significant impact on the performance of devices made with layers of these materials.

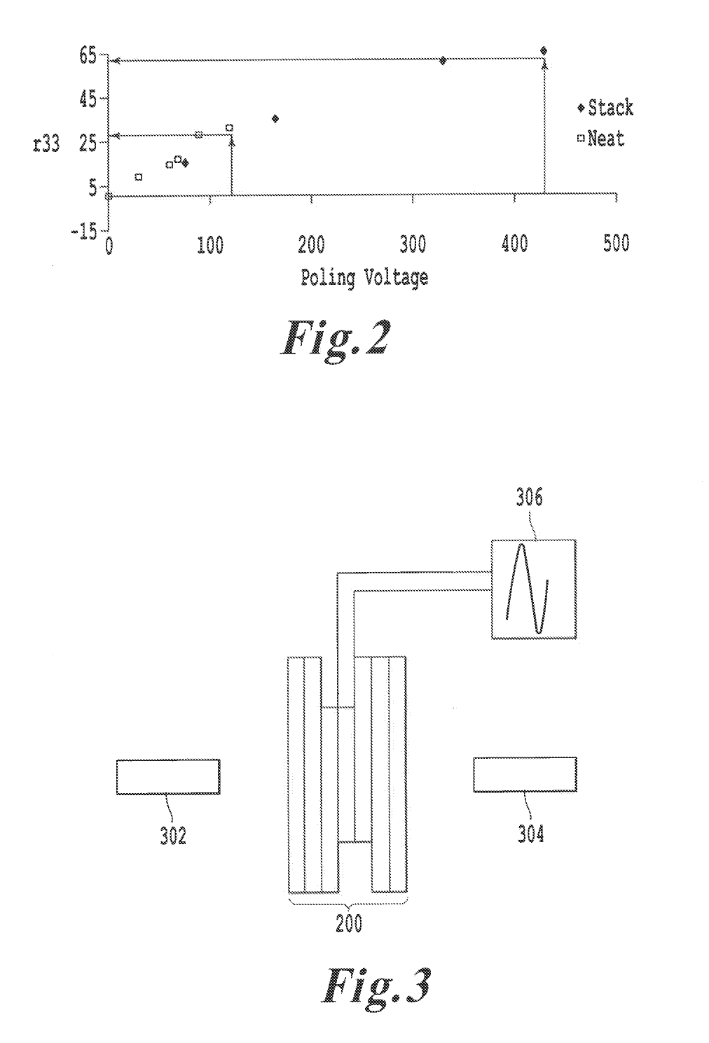

Using a sol-gel cladding layer, the electro-optic coefficient of AJL8/APC polymer was enhanced by 210% by applying a poling (i.e., orienting electric dipoles in a material by applying an electric field) field of up to 430 V without dielectric breakdown. Efficient poling can be obtained by poling for three minutes or less followed by rapid cooling. The electric-optic coefficient of the AJL8 chromophore doped in APC was enhanced by more than a factor of 2 by using a 5 micron organic/inorganic hybrid sol-gel cladding layer. FIG. 2 shows a graph for AJL8 polymer, which indicates the relationship between Pockel's coefficients, r₃₃, and the poling voltage.

The hybrid sol-gel material is based on the precursor of 3-methacryloxypropyl trimethoxysilane (MAPTMS) doped with zirconium (IV) propoxide (ZPO). Chromophore TCBD (tetracyanobutadienyl), (3-[5-(2-{4-[Bis-(2-hydroxy-ethyl)-amino]-phenyl}-vinyl)-thiophen-2-yl]-2,5-dicyano-4-[3-(3-hydroxy-propoxy)-phenyl]-hexa-2,4-dienedinitrile), is linked to the backbone of silica networks as a main-chain and then incorporated into a MAPTMS-ZPO precursor. The concentration of TCBD is ˜17.5 mol % in this embodiment. Further details of the material processing can be found in [14].

Key parameters for high performance FPI's as tunable filters include (i) large tunability, (ii) high finesse, (iii) wide tunable range, (iv) fast tune and settle times, (v) low drive voltage, (vi) high transmission, (vii) high thermal stability (damp heat cycling), (viii) high photochemical stability, (iix) high modulation frequency, and (ix) scale up and volume production at low cost.

The resonant wavelength of the FPI can be shifted by changing the optical path length via two options: the refractive index and/or the physical thickness. The refractive index can be tuned using the linear electro-optic (EO) effect (Pockel's effect) of organic polymers [1, 2] or inorganic crystals [3, 4], as well as the dc Kerr effect of liquid crystals [5, 6], while the thickness can be changed by electrostriction effect [7] and/or by the inverse piezoelectric effect of polymer materials [8]. The EO effect and the inverse piezoelectric effect are linear, while the electrostriction effect is quadratic with applied voltage [9]. Furthermore, the EO effect can be utilized for very high speed operation [10].

For a transmission configuration with normal incidence, the resonance wavelength of the FPI is determined by equation 1.

$$2 nd = m ( \frac{ψ}{π} ) λ , \qquad ( 1 )$$

where n is the index of refraction of the sol-gel film (˜1.53 at 1550 nm), d is the thickness of the film (˜1 μm), ψ the phase shift introduced by the DBR mirror, the roughness of the film, and the difference in the index of refraction between the high electro-optic coefficient material and the DBR surface, and m is an integer. A shift in the resonance wavelength happens if an electric field is applied to the cavity:

$$\frac{Δ λ}{λ} = \frac{Δ ( nd )}{nd} = \frac{Δ n}{n} + \frac{Δ d}{d} , \qquad ( 2 )$$

where Δn is the change in the refraction index of the high electro-optic coefficient material via the electro-optic effect, and Δd the change in the thickness of the film caused by mechanical effects resulting from the attractive force between the two electrodes and the converse piezoelectric effect of the aligned chromophore molecules in the poled sol-gel film.

FIG. 3 shows an exemplary Fabry-Perot test set-up. This test set-up includes an FPI 800 in accordance with FIG. 1A. A tunable laser 302 is dispose to supply a laser beam to FPI 300. An optical spectrum analyzer (OSA) 304 is disposed to measure light output from FPI 300. Tunable laser 302 may be a broadband source (such as an amplified spontaneous emission (ASE) or super luminescent LED (SLED) source). Voltage supply 306 is configured to supply a variable bias to the electrodes of the FPI 300.

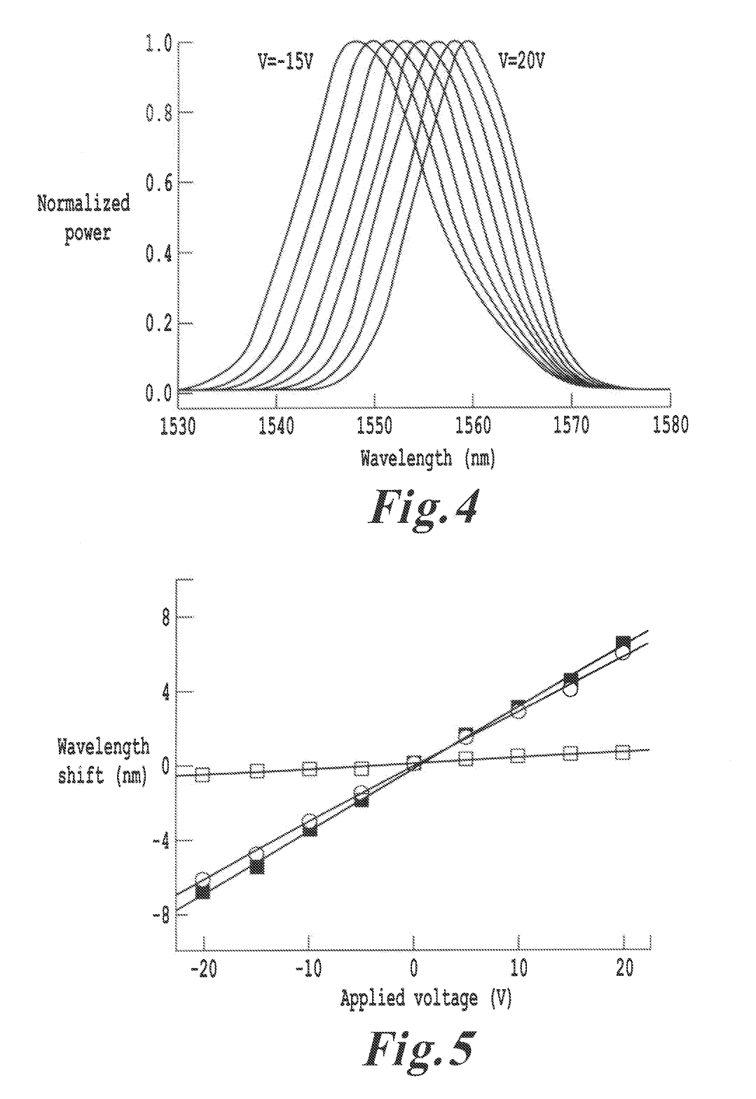

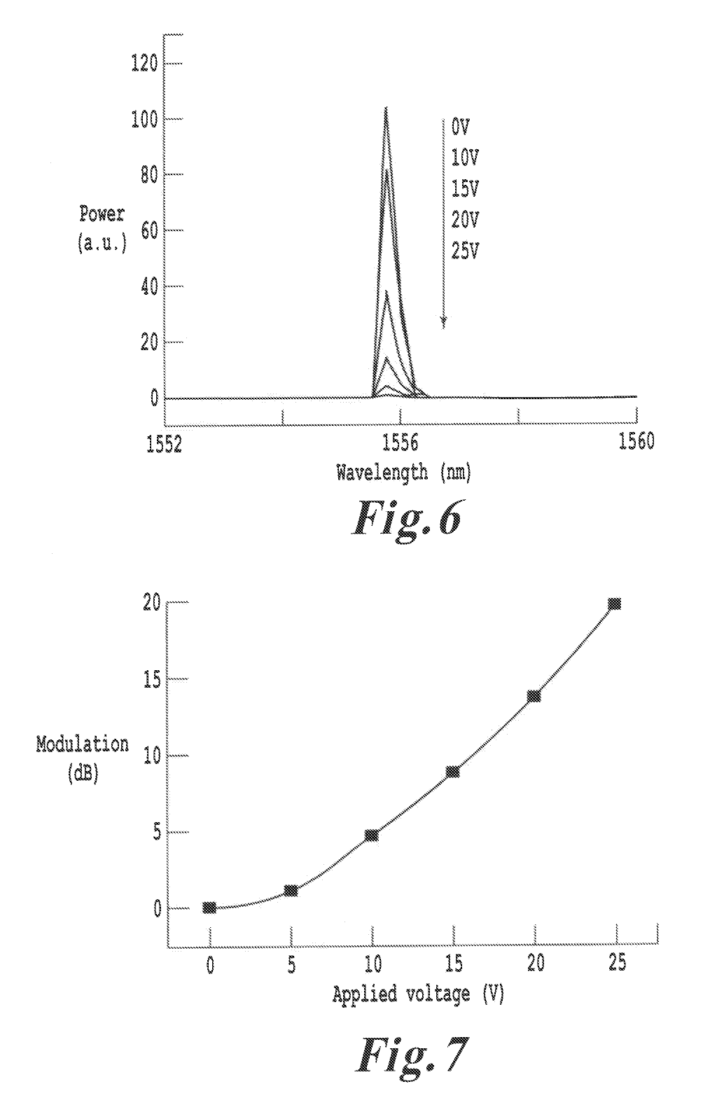

In an optical communication system, for example, a beam from an erbium doped fiber broadband source is coupled into the cavity of the optical modulator through a fiber collimator. The light transmitted through the optical modulator is led to an optical spectrum analyzer through another fiber collimator or single-mode fiber to measure the resonance wavelength and shift at different voltages applied to the electrodes of the optical modulator. A wide tunable range (>50 nm) centered at ˜1550 nm is used with an applied voltage between ±30 V. The resonant wavelength shift with applied voltage ranging from −15 V to =20 V of the sol-gel is shown in FIG. 1. As is shown in FIG. 4, a 13 nm shift is obtained when the applied voltage is varied from −15 V to +20 V for a device with a sol-gel material.

FIG. 5 is a graph that shows the dependence of the wavelength shift on the applied voltage for a device with a sol-gel material. The black squares represent the overall shift, the open or clear squares represent the shift of the empty cavity caused by piezoelectric and mechanical effects. The open or clear circles represent the wavelength shift resulting from the electro-optic effect. All the lines shown in FIG. 5 are linear fittings.

The overall wavelength shift is almost symmetric and linear with a slope of 0.33 nm/V, as shown in FIG. 5. To identify the contribution of Δd, the light is coupled into the empty cavity that is not filled with sol-gel, as shown in the upper part of FIG. 1. Thus the measured wavelength shift is solely from the contribution of mechanical and converse piezoelectric effects. The results are presented in FIG. 4 as the clear or open squares. It is clear that the shift of the empty cavity is also linear with a slope of 0.03 nm/V, indicating that the converse piezoelectric effect (a change in physical dimensions with the application of an electric field) is the dominant contribution to Ad, because the electric force is proportional to the square of the applied field. Thus the net slope that is caused by electro-optic effect is ˜0.3 nm/V.

FIG. 5 shows a variation of the transmitted power at different applied voltages for a device with a sol-gel material. It is noted that the full width at half maximum of the peaks is ˜15 nm. The effective finesse of the Fabry-Perot cavity of the device shown in FIG. 1 is estimated to be ˜70, much lower than the calculated value of 310 due to the roughness and inhomogeneity of the stacked structure of the optical modulator. Additional experiments have resulted in improved results. The improved results are based on the use of better equipment. State of the art equipment can result in much higher values. For example, by adjusting the deposition conditions of the DBR mirrors and transparent conducting oxide layers, the roughness could be significantly reduced such that finesses of ˜250 have now been achieved.

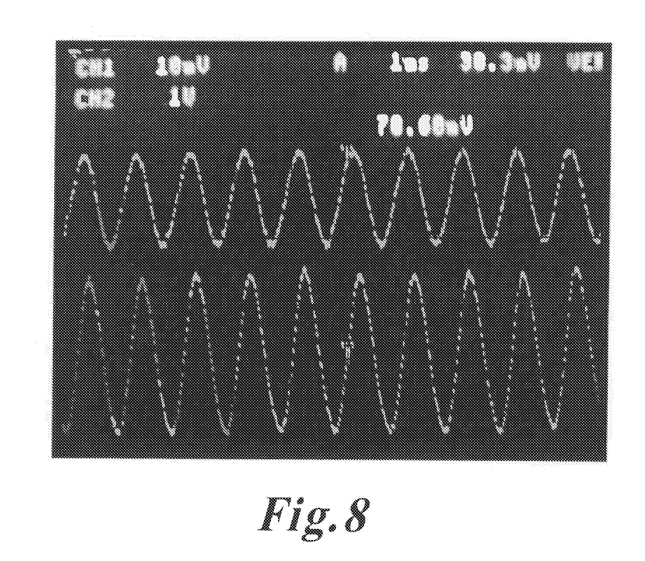

The modulation efficiency, dynamic modulation, and insertion loss of the device of FIG. 1 are characterized by coupling a laser beam from a tunable laser source into the cavity and collecting the transmitted light using either an optical spectrum analyzer or detector (see FIG. 3). The corresponding modulation efficiency is shown in FIG. 7 for a device with a sol-gel material. A modulation efficiency of 20 dB is observed at 25 V. It is also derived that a 3 dB modulation can be obtained with a voltage of ˜7 V that is available from CMOS integrated circuits.

The dynamic modulation of the Fabry-Perot modulator, with a sol-gel material, is shown in FIG. 8. The dynamic modulation is the lower trace, and the applied voltage is the upper trace in FIG. 8. Under an AC voltage of 15 V at 1K Hz, the modulation efficiency is measured to be ˜90% (10 dB). In addition, the modulated signal exactly follows the applied voltage, indicating that the modulation is produced by the electro-optic effect.

The loss in intensity using the device shown in FIG. 1 has been measured to be ˜5 dB at a resonance wavelength of 1555 nm. It has been noted that ITO has plasma reflection in the near infrared spectral range and causes high loss. Assuming the DBR mirror is lossless and the high electro-optic coefficient material has a loss of 1 dB/cm, a simulation of the transmission property of the present Fabry-Perot structure indicates that the theoretical loss of the Fabry-Perot interferometer is ˜1.3 dB, much lower than the measured value. The loss of the empty cavity was also measured to be ˜2.0 dB. Thus, the loss of ˜3.0 dB is caused by the defects of the cavity during the fabrication process. Indeed, if it is assumed that the high electro-optic coefficient material roughness is 1%, the loss at the resonance wavelength increases by another 2.0 dB. So a high-quality high electro-optic coefficient material is a key factor for low-loss FPI's.

It has to be noted that the effective voltage applied to the sol-gel film is low due to the influence of the DBR mirrors. The effective voltage drop V_{eff} to the film can be calculated by [15]

$${V}_{eff} = \frac{{V}_{o}}{1 + \frac{λ {ɛ}_{S}}{4 d} ( \frac{m}{{ɛ}_{H} {n}_{H}} + \frac{q}{{ɛ}_{L} {n}_{L}} )} = β {V}_{0} , \qquad ( 3 )$$

where ε is the dielectric constant and lower scripts S, H, and L denote sample, high index Ta₂O₅ (nH=2.1), and low index SiO₂ (n_{L}=1.444), m and q are the layer numbers of Ta₂O₅ and SiO₂ (m=q=8), respectively, and

$$β = {[ 1 + \frac{λ {ɛ}_{S}}{4 d} ( \frac{m}{{ɛ}_{H} {n}_{H}} + \frac{q}{{ɛ}_{L} {n}_{L}} ) ]}^{- 1}$$

is the fraction of effective voltage applied to the sol-gel film over the total applied voltage. β is calculated to be ˜0.25. That means only −25 % of the field is applied to the sol-gel film. So, by optimizing the DBR mirror, high efficiency modulation can be realized at much lower drive voltage. Alternatively, conductive films of ZnO¹² and ITiO¹³ (titanium doped indium oxide), which have very low extinction at 1550 nm, can be used as electrodes immediately next to the sol-gel film. They will allow the full drop of the applied voltage across the high electro-optic coefficient material without introducing extra loss.

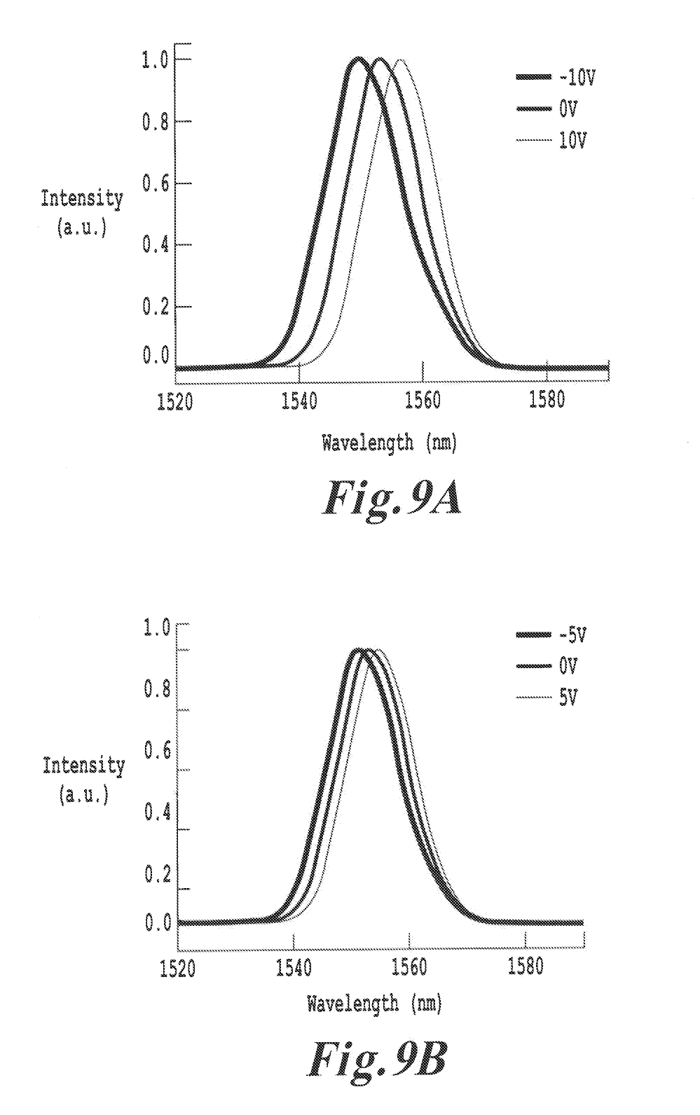

FIGS. 9A and 9B show exemplary results obtained using an embodiment of the present invention using a sol-gel material. Embodiments of the present invention have realized electro-optic modulation using a shift in the resonance wavelength of the electro-optic cavity and a modulation efficiency of 20 dB at 1550 nm has been obtained. FIG. 9A shows 60% modulation at 10 V. FIG. 9B shows 32% modulation at 5 V. The insertion loss of the modulator has been measured to be 5 dB.

Furthermore, embodiments of the present invention are applicable to analog radio frequency links, satellite communications, fiber to home systems, high-speed free-space modulation, optical switch arrays, and tunable optical filters for commercial and defense applications.

Although only certain exemplary embodiments of the invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

1. An optical device comprising:
a first transparent substrate;
a first electrode disposed on the first transparent substrate;
a first mirror disposed on the first electrode;
a high electro-optic coefficient polymer or sol-gel material disposed on the first mirror;
a second mirror disposed on the high electro-optic coefficient polymer or sol-gel material and at least partially sandwiching the high electro-optic coefficient polymer or sol-gel material between the first and second mirrors;
a second electrode disposed on the second mirror; and
a second transparent substrate disposed on the second electrode.

2. The optical device of claim 1, wherein at least one of the first mirror and second mirror is a distributed Bragg reflector.

3. The optical device of claim 1, wherein at least the first or second electrode includes indium tin oxide.

4. The optical device of claim 2, wherein the distributed Bragg reflector has a reflectivity of 99% at a wavelength of 1550 nm.

5. The optical device of claim 1, wherein the first and second electrodes are transparent.

6. The optical device of claim 1, wherein the high electro-optic coefficient polymer or sol-gel material includes one of AJL8 or chromophore TCBD.

7. The optical device of claim 6, wherein the chromophore TCBD is (3-[5-(2-{4-[Bis-(2-hydroxy-ethyl)-amino]-phenyl}-vinyl)-thiophen-2-yl]-2,5-dicyano-4-[3-(3-hydroxy-propoxy)-phenyl]-hexa-2,4-dienedinitrile).

8. The optical device of claim 1, wherein the first and second mirrors are disposed to form a gap, which is partially filed by the sol-gel material.

9. The optical device of claim 1, wherein the high electro-optic coefficient polymer or sol-gel material is biased by a voltage source that establishes an electric field between the first and second electrodes.

10. The optical device of claim 1, wherein the at least one of the first and second electrodes includes zinc.

11. The optical device of claim 1, wherein the sol-gel material is disposed on the first mirror.

12. A method of making an optical modulator comprising:
depositing a first transparent electrode on a first transparent substrate;
depositing a first low loss mirror onto the first transparent electrode;
depositing a high electro-optic coefficient polymer or sol-gel material onto the low loss mirror;
depositing a second low loss mirror onto the high electro-optic coefficient polymer or sol-gel material;
depositing a second transparent electrode onto the second low loss mirror; and
depositing a second transparent substrate on the second electrode.

13. The method of claim 12, wherein the depositing the first low loss mirror includes depositing a distributed Bragg reflector.

14. The method of claim 12, wherein the depositing the first electrode includes depositing indium tin oxide.

15. The method of claim 13, wherein the depositing the distributed Bragg reflector includes depositing a distributed Bragg reflector that has a reflectivity of 99% at a wavelength of 1550 nm.

16. The method of claim 12, wherein the depositing the first electrode includes depositing a transparent electrode.

17. The method of claim 12, wherein the depositing the high electro-optic coefficient polymer or sol-gel material includes depositing chromophore TCBD or AJL8.

18. The method of claim 17, wherein the depositing chromophore TCBD includes depositing (3-[5-(2-{4-[Bis-(2-hydroxy-ethyl)-amino]-phenyl}-vinyl)-thiophen-2-yl]-2,5-dicyano-4-[3-(3-hydroxy-propoxy)-phenyl]-hexa-2,4-dienedinitrile).

19. An optical device comprising:
a first transparent substrate;
a first mirror disposed on the first transparent substrate;
a first electrode disposed on the first mirror;
a high electro-optic coefficient polymer or sol-gel material disposed on the first electrode;
a second electrode disposed on the high electro-optic coefficient polymer or sol-gel material and at least partially sandwiching the sol-gel material between the first and second electrodes;
a second mirror disposed on the second electrode; and
a second transparent substrate disposed on the second mirror.

20. The optical device of claim 19, wherein the sol-gel material is disposed on the first electrode.
